(19) United States
(12) Patent Application Publication
(10) Pub. No.: US 2002/0070470 A1
(43) Pub. Date: Jun. 13, 2002

(54) Method and apparatus for sealing a plastic injection molding tool

(75) Inventors: Helmut Eckardt, Meinerzhagen (DE); Marc Wulfrath, Kierspe-Vollme (DE); Christoph Jaroschek, Bielefeld (DE); Jurgen Ehritt, Hilchenbach (DE); Christof Bloemeke, Geseke (DE); Mathias Hunold, Geseke (DE)

Correspondence Address: James M. Smith, Esq., HAMILTON, BROOK, SMITH & REYNOLDS, P.C., Tow Militia Drive, Lexington, MA, 02421-4799, US

(73) Assignee: Battenfeld GmbH, Meinerzhagen (DE)

(21) Appl. No.: 09/960,619

(22) Filed: Sep. 21, 2001

(30) Foreign Application Priority Data
Sep. 23, 2000 (DE) 100 47 227.3

(51) Int. Cl. B29C 45/00; B29C 45/26; B29C 45/76

(52) U.S. Cl. 264/40.1; 264/40.3; 264/500; 264/328.1; 264/328.9; 425/542; 425/DIG. 47

(57) ABSTRACT

The invention relates to a method for injection molding a plastic molded part in an injection mold, comprising a) injecting a specified amount of plastic melt into the injection mold; b) introducing a compressed fluid between a part of the wall of the injection mold and the injected plastic melt; c) allowing the plastic melt to cool until the plastic molded part is self-supporting; and d) removing the plastic molded part from the mold. The invention specifies that, during or after step a) and during or before step b), the cavity of the injection mold is sealed against the environment, preferably by activating at least one seal.

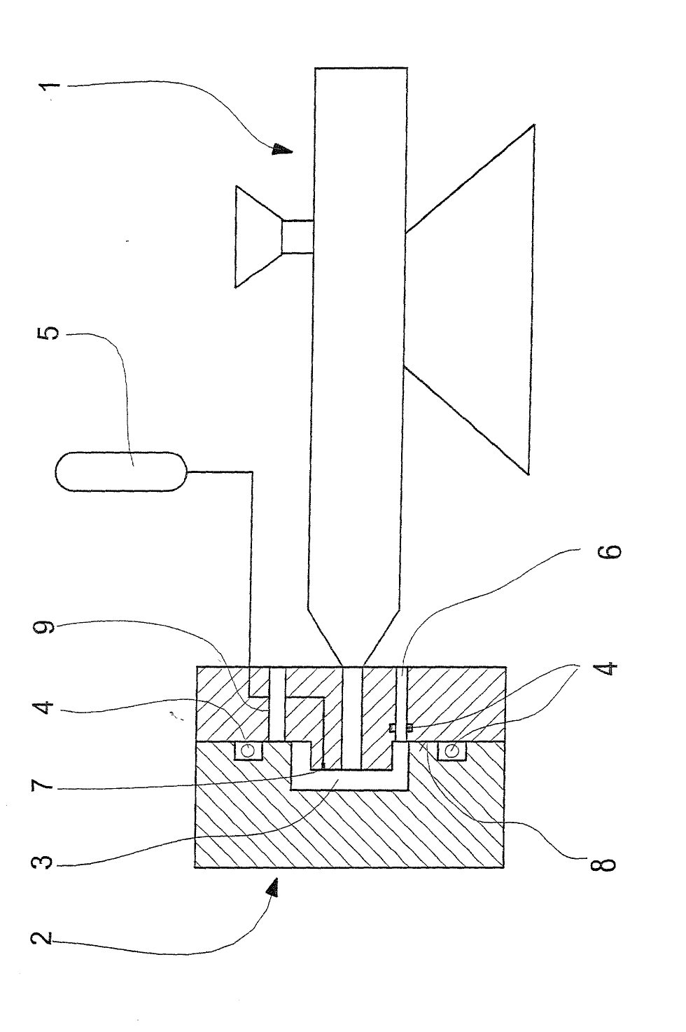

### RELATED APPLICATION

This application claims priority to German Application 100 47 227.3-16, filed on Sep. 23, 2000, the teachings of which are incorporated herein by reference.

### BACKGROUND OF THE INVENTION

A method for injection molding a plastic molded part is known from International Application WO 90/06220 A1. By this method, a quantity of plastic melt sufficient to form the molded part is first introduced into the cavity of an injection mold. Since the plastic shrinks while cooling, sink marks can occur unless special precautions are taken. According to this publication, sink marks are avoided by introducing compressed gas as a cushion between the cavity surface and the plastic melt. Naturally, it must be assured that this gas cushion is built up in a very specific way and, after the melt has solidified, can again be eliminated. Two ways of solving this problem are described:

One way is to use valves capable of sealing off the gas through an appropriate valve seat. By actuating (axially displacing) the valve shaft, the valve can optionally be set to “open” or “closed.” By this means, in combination with an appropriate gas control, the desired gas cushion can be built up and taken down.

Alternatively, sintered metal can be used. A porous metal element is placed at the transition point in the mold, where the gas cushion is to be created. The compressed gas can flow through this porous metal element, but not so the plastic melt. In this way, gas can be supplied under controlled conditions without any backflow of melt.

However, these solutions have various disadvantages: The valves must have a mechanical control so that they can be opened and closed in a controlled manner. This presupposes a certain minimum space for the corresponding arrangement. This can result in a complicated and expensive structure of valve elements. With the alternative, namely the use of porous sintered metals, the problem arises that one cannot prevent the process whereby parts of the sintered surface gradually admix with tiny melt particles. This is a creeping process, which impairs the operational result only gradually. Reproducibility of the production process thus is not assured.

Another method of a similar generic type is known from International Application WO 93/01039 A1. The special problem here is how the gas cushion, which has been introduced between the cavity surface and the plastic melt, can be prevented from spreading out undesirably and coming into action at places where this is not wanted. The solution proposed there is to roughen the cavity surface at places where the gas cushion is supposed to build up. Those places on the surface, which border the gas cushion but themselves no longer should have gas applied to them, are made smooth. The roughness of the surface therefore defines the region where the gas cushion is supposed to form and act.

This method requires a corresponding technical processing of the mold: The places where the cushion is supposed to act must be treated (roughened). This represents an irreversible process for the mold, which furthermore is quite expensive. Further, the compressed gas can act as far as the separation surfaces of the mold. In some cases, a very high pressure is required, which acts counter the closure force of the mold and presses the two mold halves apart, so that the compressed gas can escape. The pressure is no longer applied to the melt, and the desired result is not achieved.

The German Publication DE 197 46 802 A1 likewise belongs to this generic type, but provides no indication how to eliminate the above disadvantages.

### SUMMARY OF THE INVENTION

Starting from this known prior art, one aspect of the invention is to provide a method and an apparatus which make it possible to create the desired pressure profile between the melt and a cavity wall.

In one embodiment, a method for injection molding a plastic molded part is provided which includes injecting a specified amount of plastic melt into the injection mold, introducing a compressed fluid between a part of the wall of the injection mold and the injected plastic melt, allowing the plastic melt to cool until the plastic molded part is self-supporting, and removing the plastic molded part from the mold. In a particular embodiment, during or after the step of injecting a specified amount of plastic melt into the injection mold and during or before the step of introducing the compressed fluid, the cavity of the injection mold is sealed against the environment.

By sealing the mold in this way, the applied pressure is kept in the cavity, and the fluid thus acts on the melt at the desired level.

In one embodiment, the activation of the seal, of which there is at least one, is controlled and/or regulated. It is advantageous if the seal, of which there is at least one, is controlled and/or regulated as a function of time, pressure, or path, the plastic melt or the compressed fluid being used as the control or regulation element. It thus becomes possible to activate the seal, for example, after introducing a specified amount of plastic melt, and thus first to allow the air in the cavity to escape through this leak at the contact surfaces between the two mold halves, and to close this leak before applying the fluid cushion. Analogously, the seal can be activated, for example, before introducing the fluid.

So that this seal can also be used with more complex molded parts which, for example, have undercuts and thus require slide bars in the injection mold, the invention proposes that, during or after the step of injecting a specified amount of plastic melt into the injection mold and before the step of introducing a compressed fluid, the cavity of the injection mold is sealed against the environment by activating a seal on other moving parts.

Another possibility is to use, for example, laminar seals made of rubber, which develop their sealing action as soon as the mold is closed. However, so that the necessary venting of the cavity will also be assured here, the invention provides for a relief hole through which air can escape during the step of injecting a specified amount of plastic mold into the injection mold. Before or during the step of introducing a compressed fluid, this hole is closed, and the desired pressure can then be built up. According to a further development, a counter-pressure is built up through these relief holes by introducing a compressed fluid through them, whose pressure is less than the pressure of the compressed fluid that is introduced into the cavity through the injection module.

The inventive injection mold for injection molding a plastic molded part is characterized in that at least one of the two halves of the mold is formed with a seal, to seal the cavity of the injection mold against the environment. It is advantageous to activate the seal through at least one activator. The plastic melt or the fluid can be used as the activator. The interior pressure of the mold is determined by suitable means, for example, a pressure sensor, and this internal pressure of the mold again is a characteristic parameter for the injected quantity of plastic melt. The seal is activated beginning with a specified minimum quantity. For example, an inserted hose body can here be filled with a fluid, thus changing the volume of the seal and closing the minimum gap between the mold halves. But it is also conceivable to make a seal from a deformable material such as rubber. After activation by the fluid or the plastic melt, the contact pressure, which presses the two mold halves against one another, that is the closure pressure, is increased and thus the seal is activated and the cavity is sealed.

According to a further development, moving parts such as a slide bar or ejector, which have an opening into the cavity, and which therefore at least make possible a gas-permeable connection to the environment, are also equipped with a seal.

The proposed method and the proposed apparatus make it possible to apply the desired fluid pressure between the cavity wall and the melt in such a way that the pressure cannot decay through the contact surfaces between the two mold halves.

### BRIEF DESCRIPTION OF THE DRAWING

The Figure schematically shows an embodiment of the invention.

The foregoing and other objects, features and advantages of the invention will be apparent from the following more particular description of preferred embodiments of the invention, as illustrated in the accompanying drawing. The drawing is not necessarily to scale, emphasis instead being placed upon illustrating the principles of the invention.

### DETAILED DESCRIPTION OF THE INVENTION

The Figure shows a plasticizing and injection unit 1 and an injection mold 2 with the cavity 3, which is sealed against the environment by the seals 4. The injection unit 1 is connected to the cavity 3, to introduce thermoplastic melt into the cavity. An injection module 7 is disposed in the cavity wall. It is connected to a compressed fluid unit 5 through ducts. In one embodiment, nitrogen is introduced through the ducts between the cavity wall and the plastic melt. After or shortly before the melt has been completely introduced into the cavity 3, the seal 4 is activated and thus blocks the cavity against the environment along the sealing surface 8. A schematically shown ejector 6 likewise has a seal 4. It is thus possible to seal these points too against the environment, through which gas could otherwise escape. If a non-activatable seal is used, the cavity alternatively can be vented through one or more relief holes 9.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for injection molding a plastic molded part in an injection mold, comprising:
a) injecting a specified amount of plastic melt into the injection mold;
b) introducing a compressed fluid between a part of the wall of the injection mold and the injected plastic melt;
c) allowing the plastic melt to cool until the plastic molded part is self-supporting;
d) removing the plastic molded part from the mold; and
e) sealing the cavity of the injection mold against the environment during or after step a) and during or before step b).

2. The method of claim 1, wherein the fluid includes a compressed gas.

3. The method of claim 1, wherein the cavity of the injection mold is sealed against the environment by activating at least one seal.

4. The method of claim 3, wherein the activation of the seal is controlled and/or regulated.

5. The method of claim 1, wherein the fluid includes a compressed gas and the cavity of the injection mold is sealed against the environment by activating at least one seal, and wherein the seal is controlled and/or regulated as a function of time, pressure, or path, the plastic melt or the compressed gas being used as the control or regulation element.

6. The method of claim 1, wherein during or after step a) and during or before step b), the cavity of the injection mold is sealed against the environment by activating a seal associated with at least one moving part.

7. The method of claim 1, wherein during or before step b), at least one relief hole is closed.

8. The method of claim 7, wherein after step a), a compressed fluid is introduced through the relief hole, such that its pressure is less than the pressure of the compressed fluid which is introduced through an injection module.

9. An injection mold for injection molding a plastic molded part, comprising:
a mold with a cavity, the mold including two halves;
at least one fluid injection element, which introduces compressed fluid from a wall of the cavity into the cavity, so that a fluid cushion forms between the wall and plastic melt that has been introduced into the mold; and
an activatable seal between the two halves of the mold to seal the cavity of the injection mold against the environment after the melt has been introduced into the mold.

10. The injection mold of claim 9, wherein the compressed fluid includes a compressed gas.

11. The injection mold of claim 9, wherein a relief hole is provided to vent the cavity.

12. The injection mold of claim 9, wherein the seal is activated by at least one activator.

13. The injection mold of claim 12, wherein the plastic melt or the fluid is used as the activator.

14. The injection mold of claim 9, wherein the seal is constructed as a hose body, whose volume can be changed by a fluid.

15. The injection mold of claim 9, wherein the seal is constructed of a deformable material.

16. The injection mold of claim 9, wherein the deformable material includes rubber.

17. The injection mold of claim 9, wherein moving parts, which have an opening into the cavity, are equipped with a seal.

18. An apparatus for injection molding a plastic molded part, comprising:
an injection mold including at least two halves and a cavity therein, there being an activatable seal between the two halves; and
a fluid injection element which introduces a compressed fluid into the cavity.

19. A method for injection molding a plastic molded part, comprising:
providing an injection mold that includes at least two halves and a cavity therein;
introducing plastic melt into the cavity, introducing a compressed fluid into the cavity to form a fluid cushion between a wall of the cavity and the plastic melt that has been introduced into the cavity; and
sealing the injection mold from the environment before or during the step of introducing a compressed fluid into the cavity.

20. The method of claim 19, wherein during or after the step of introducing a plastic melt into the cavity and during or before the step of introducing a compressed fluid into the cavity, the cavity of the injection mold is sealed against the environment by activating a seal associated with at least on moving part.
